(19) United States
(12) Patent Application Publication
(10) Pub. No.: US 2017/0206587 A1
(43) Pub. Date: Jul. 20, 2017

(54) TIRE RECOMMENDATION ENGINE

(71) Applicant: DEALER TIRE, LLC, CLEVELAND, OH (US)

(72) Inventors: Matthew NEIDERT, Akron, OH (US); Maurio POWELL, Cleveland, OH (US); Jim GRANT, Hudson, OH (US); Carey JAROS, Shaker Heights, OH (US); Gary BAILEY, Uniontown, OH (US); Jeff CARPENTER, Westlake, OH (US)

(73) Assignee: DEALER TIRE, LLC, CLEVELAND, OH (US)

(21) Appl. No.: 15/474,280

(22) Filed: Mar. 30, 2017

Related U.S. Application Data
(63) Continuation of application No. 13/647,653, filed on Oct. 9, 2012.
(60) Provisional application No. 61/684,294, filed on Aug. 17, 2012.

(51) Int. Cl. G06Q 30/06

(52) U.S. Cl. CPC G06Q 30/0631

(57) ABSTRACT

A method of generating a tire recommendation includes receiving vehicle data and historical driving data of a user, retrieving, by a computer, a first set of tire names having associated vehicle fitment data that corresponds to the vehicle data, and selecting, by the computer, a first criteria based on the historical driving data. The method further includes identifying a final set of tire names, by identifying tire names in the first set of tire names that have associated tire performance data that meet the first criteria. The method also includes identifying, by the computer, a tire name from the final set of tire names having a highest associated sales history datum as a first tire recommendation, and displaying, by the computer, the first tire recommendation.

### CROSS-REFERENCES TO RELATED APPLICATIONS

This application is a Continuation of U.S. patent application Ser. No. 13/647,653, filed Oct. 9, 2012, and entitled “TIRE RECOMMENDATION ENGINE”, which claims the priority of U.S. Patent Provisional Application No. 61/684,294, filed on Aug. 17, 2012, and entitled “TIRE RECOMMENDATION ENGINE”. The entire contents of each of the above-identified patent applications are incorporated herein by reference.

### FIELD OF INVENTION

The present disclosure relates to a system and method of recommending tires to a user. More particularly, the present disclosure relates to a system and method of recommending tires to a user based on driver history data.

### BACKGROUND

Interactive, computer-based systems that recommend products to consumers may rely on product information provided by the manufacturer, and may supplement that information with reviews provided by other consumers. Where objective, test-based information is available, such as with consumer testing organizations, it is left to the user to sort through and to interpret the information for relevance, leading to the possibility of misunderstanding and error. Some known systems provide a recommendation to a consumer based on preferences identified by the consumer, without inquiring as to the consumers actual prior use of related products.

### SUMMARY OF THE INVENTION

In one embodiment, a computerized method of recommending a tire to a customer includes providing a database of tire names, each tire name having associated therewith a vehicle fitment datum, tire performance data, a sales history datum, and a price datum. The method further includes receiving a request from a user for a tire recommendation. The request includes vehicle data and driver history data, wherein each driver history datum has an associated score. The method also includes retrieving, by a computer from the database, a first set of tire names having associated vehicle fitment data that corresponds to the vehicle data, and selecting, by the computer, a first criteria. The method also includes identifying a second set of tire names, by filtering the first set of tire names to remove tire names having associated tire performance data that fails to meet the first criteria. The method further includes selecting, by the computer, a second criteria, and identifying a final set of tire names, by removing tire names having associated tire performance data that fails to meet the second criteria. The method also includes identifying, by the computer, a tire name from the final set of tire names having a highest associated sales history datum as a first tire recommendation, and displaying, by the computer, the first tire recommendation.

In another embodiment, a method of generating a tire recommendation includes receiving vehicle data and historical driving data of a user, retrieving, by a computer, a first set of tire names having associated vehicle fitment data that corresponds to the vehicle data, and selecting, by the computer, a first criteria based on the historical driving data. The method further includes identifying a final set of tire names, by identifying tire names in the first set of tire names that have associated tire performance data that meet the first criteria. The method also includes identifying, by the computer, a tire name from the final set of tire names having a highest associated sales history datum as a first tire recommendation, and displaying, by the computer, the first tire recommendation.

In yet another embodiment, a method of recommending a tire includes receiving a request from a user for a tire recommendation. The request includes vehicle data and driver history data, wherein each driver history datum has an associated score. The method further includes retrieving, by a computer, a first set of tire names having associated vehicle fitment data that corresponds to the vehicle data, and selecting, by the computer, a first criteria. The method also includes identifying a final set of tire names by filtering the first set of tire names to remove tire names having associated tire performance data that fails to meet the first criteria. The method further includes identifying, by the computer, a tire name from the final set of tire names having a highest associated sales history datum as a first tire recommendation, and displaying, by the computer, the first tire recommendation.

### BRIEF DESCRIPTION OF DRAWINGS

In the accompanying drawings, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale and the proportion of certain elements may be exaggerated for the purpose of illustration.

FIG. 1 illustrates one embodiment of a system for providing tire recommendations;

FIG. 2 illustrates exemplary data in one embodiment of a tire database;

FIG. 3 illustrates exemplary data in one embodiment of a request for a recommendation;

FIG. 4 illustrates exemplary data in one embodiment of a first set of tire names;

FIG. 5 illustrates exemplary data in one embodiment of a second set of tire names;

FIG. 6 illustrates exemplary data in one embodiment of a final set of tire names;

FIG. 7 illustrates an exemplary display of tire recommendations; and

FIG. 8 illustrates a flowchart showing one embodiment of a method of providing a first tire recommendation.

### DETAILED DESCRIPTION

“Computer-readable medium,” refers to any tangible medium that participates directly or indirectly in providing signals, instructions and/or data to one or more processors for execution. Such a medium may take many forms, including but not limited to, non-volatile media, volatile media, and transmission media. Non-volatile media may include, for example, optical disks, magnetic disks or so-called “memory sticks.” Volatile media may include dynamic memory. Transmission media may include coaxial cables, copper wire, and fiber optic cables. Transmission media can also take the form of acoustic or light waves, such as those generated during radio-wave and infra-red data communications, or take the form of one or more groups of signals. Common forms of computer-readable media include, for example, a floppy disk, a flexible disk, hard disk, magnetic tape, or any other magnetic medium, a CD-ROM, any other optical medium, punch cards, papertape, any other physical medium with patterns of holes, a RAM, a PROM, an EPROM, an EEPROM, a FLASH-EPROM, any other memory chip or cartridge, a carrier wave/pulse, or any other medium from which a computer, a processor or other electronic device can read.

A “computer station” is any electronic device that has an operating system and includes, without limitation, desktop computers, laptop computers, tablets, mobile telephones, and other handheld devices.

“Logic,” as used herein, includes but is not limited to hardware, firmware, software and/or combinations of each to perform a function(s) or an action(s), and/or to cause a function or action from another component. For example, based on a desired application or need, logic may include a software controlled microprocessor, discrete logic such as an application specific integrated circuit (ASIC), a programmed logic device, memory device containing instructions, or the like. Logic may also be fully embodied as software.

“Signal,” as used herein, includes but is not limited to one or more electrical or optical signals, analog or digital signals, one or more computer or processor instructions, messages, a bit or bit stream, or other means that can be received, transmitted, and/or detected.

“Software,” as used herein, includes but is not limited to one or more computer readable and/or executable instructions that cause a computer or other electronic device to perform functions, actions, and/or behave in a desired manner. The instructions may be embodied in various forms such as routines, algorithms, modules or programs including separate applications or code from dynamically linked libraries. Software may also be implemented in various forms such as a stand-alone program, a function call, a servlet, an applet, instructions stored in a memory, part of an operating system or other type of executable instructions. It will be appreciated by one of ordinary skill in the art that the form of software is dependent on, for example, requirements of a desired application, the environment it runs on, and/or the desires of a designer/programmer or the like.

“User,” as used herein, includes but is not limited to one or more persons, software, computers or other devices, or combinations of these.

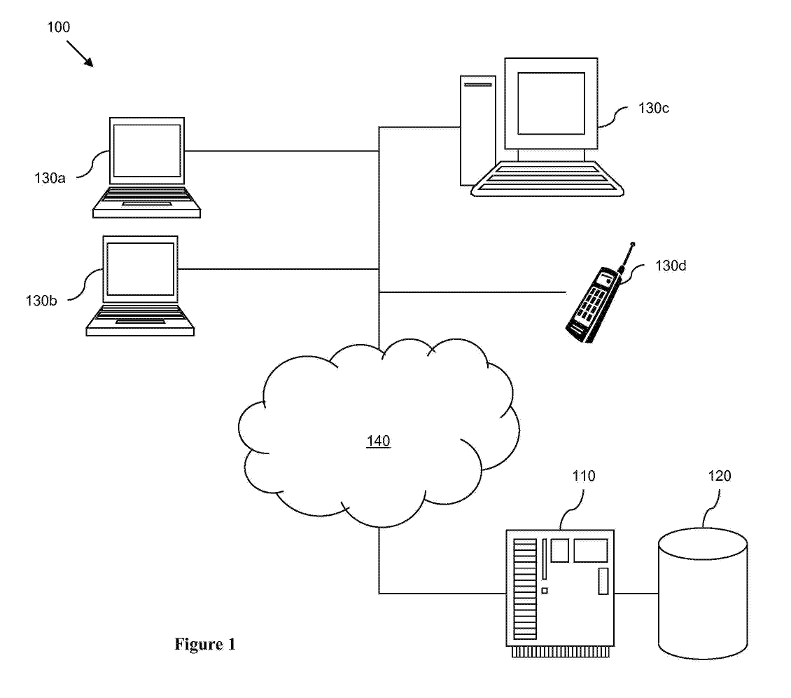

FIG. 1 illustrates one embodiment of a system 100 for providing tire recommendations to a user. The system 100 includes a tire computer station 110 in signal communication with a tire database 120. In the illustrated embodiment, the tire computer station 110 is shown as a mainframe connected to a separate database. However, it should be understood that any type of computer station may be employed, and that the tire database 120 may be physically stored on the tire computer station 110. Alternatively, the tire database may be remote from the tire computer station, and the tire computer station may be in signal communication with the tire database over a network such as a local area network (LAN), a wide area network (WAN), the Internet, or other network.

In one embodiment, the tire computer station 110 is a dedicated machine for providing tire recommendations. In an alternative embodiment, the tire computer station 110 may perform multiple functions. In either embodiment, the tire computer station itself, a processor of the tire computer station, or software that performs a method of providing a tire recommendation to a user may be referred to as a tire recommendation engine.

The system 100 further includes a plurality of user computer stations 130a-d that are in signal communication with the tire computer station 110 via the Internet 140. In the illustrated embodiment, the user computer stations 130a-d are shown as laptop computers 130a,b, desktop computers 130c, and mobile phones 130d. However, it should be understood that any type of computer station may be employed as a user computer station. While four user computer stations are shown, it should be understood that any number of user computer stations may be employed.

In an alternative embodiment (not shown), the user computer stations 130 may be in signal communication with the tire computer station 110 via an LAN, WAN, or any other network. In another alternative embodiment (not shown), the tire recommendation engine may be housed on a user computer station, such as a kiosk.

In operation, a user enters a request through a user computer station 130 for a tire recommendation. The request includes user specific data, and is transmitted to the tire computer station 110. Based on the user specific data, the tire computer station 110 identifies one or more tire names from the tire database 120 and provides at least a first tire recommendation to the user. The tire computer station 110 may also provide a second and third tire recommendation, or any number of additional recommendations.

In one known embodiment, the user is presented with a series of questions to formulate the request for a tire recommendation. For example, the user may be asked the make, model, and year of the car, and other questions about the vehicle. The user may also be asked questions about her past driving habits. For example, the user may be asked for the annual mileage of the vehicle, the weather conditions that the vehicle is exposed to, the user's driving style, special conditions that the vehicle experiences, and other driving history questions.

In one known embodiment, the questions are presented in multiple choice format. For example, when the user is asked for the annual mileage of the vehicle, she is presented with a choice of: (a) under 5,000 miles, (b) 5,000-10,000 miles, (c) 10,000-15,000 miles, (d) 15,000-20,000, and (e) over 20,000 miles. As another example, when the user is asked for the weather conditions the vehicle is exposed to, she is presented with a choice of: (a) hot sunny days, (b) some rain, (c) steady rain, (d) snow, rain, ice, and (e) extreme winter. As yet another example, when the user is asked for her driving style, she is presented with a choice of: (a) slow and steady, (b) easy going, (c) typical, (d) spirited, and (e) fast & lively.

As still another example, when the user is asked about special conditions that the vehicle experiences, she is presented with a choice of: (a) off-road, (b) towing things, and (c) heavy loads. When the user is asked about special conditions, she may be permitted to select more than one special condition. In one known embodiment, the user is only asked about special conditions if the user indicates that her vehicle is a truck.

It should be understood that the questions related to driving history are merely exemplary and not intended to be limiting. Likewise, the answer choices are merely exemplary and not intended to be limiting.

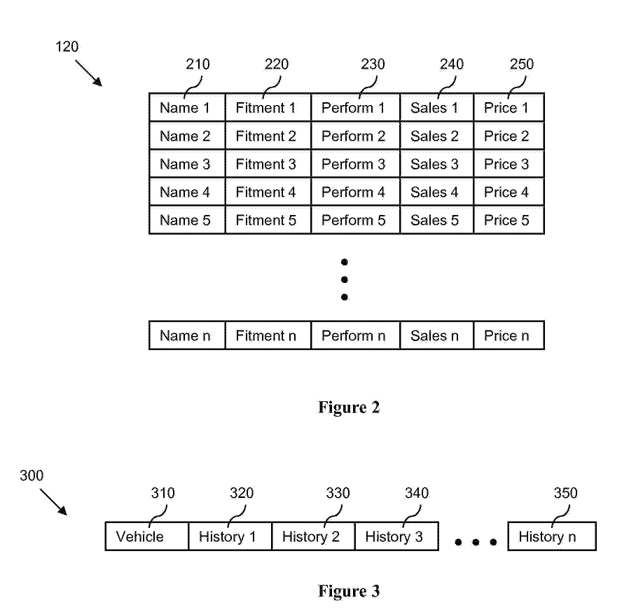

FIG. 2 illustrates exemplary data stored in one embodiment of the tire database 120. The tire database 120 includes a plurality of tire names 210, with each tire name 210 having associated therewith vehicle fitment data 220, tire performance data 230, sales history data 240, and price data 250. For each data type, the database may house a single datum or a plurality of datum. For example, the tire name 210 may include one or more of a manufacturer name, a model name, a model number, a size, and other identification data. The vehicle fitment data 220 may include a list of compatible vehicles. Alternatively, the vehicle fitment data 220 may include one or more of a size, a type, and other specification data that may be correlated to a vehicle type. The performance data 230 may include one or more of a tread wear grade, a manufacturers tread life warranty, a tread wear score, a traction score, a tire performance type value, and other performance data. The performance data may be based on an established standard, such as UTQG, or it may be based on a proprietary standard. The sales data 240 may include one or more of national manufacturer sales data, national store sales data, regional or local manufacturer sales data, regional or local store sales data, or other sales data. The price data 250 may include a manufacturers suggested retail price, a store price, or other price data.

FIG. 3 illustrates exemplary data in one embodiment of a request 300 for a tire recommendation. The request 300 includes vehicle data 310 and driver history data 320. The vehicle data 310 may include one or more of a vehicle make, a vehicle model, a vehicle year, or other vehicle information. The driver history data 320 may include one or more of an annual mileage, weather conditions, driving style, and other driver history data. In one embodiment, each driver history datum has an associated score. For example, each datum may be assigned a score of 1 to 5 or a score of 1 to 10. It should be understood, however, that any score or weight factor may be assigned to each driver history datum.

In one example, an annual mileage of less than 5,000 miles is given a score of 1, an annual mileage of 5,000-10,000 miles is give a score of 2, an annual mileage of 10,000-15,000 miles is given a score of 3, an annual mileage of 15,000-20,000 miles is given a score of 4, and an annual mileage of greater than 20,000 is given a score of 5. However, it should be understood that such an assignment of scores is merely exemplary, and any scoring system may be used.

In another example, a weather condition of “hot and sunny” is given a score of 1, a weather condition of “some rain” is given a score of 2, a weather condition of “steady rain” is given a score of 3, a weather condition of “snow, rain, ice” is given a score of 4, and a weather condition of “extreme winter” is given a score of 5. However, it should be understood that such an assignment of scores is merely exemplary, and any scoring system may be used.

In yet another example, a driving style of “slow & steady” is given a score of 1, a driving style of “easy going” is given a score of 2, a driving style of “typical” is given a score of 3, a driving style of “spirited” is given a score of 4, and a driving style of “fast & lively” is given a score of 5. However, it should be understood that such an assignment of scores is merely exemplary, and any scoring system may be used.

In one embodiment, a score may also be assigned to a vehicle age. For example, a vehicle that is less than three years old may be assigned a score of 1, a vehicle that is three to five years old may be assigned a score of 2, and a vehicle that is over five years old is assigned a score of 3. However, it should be understood that such an assignment of scores is merely exemplary, and any scoring system may be used.

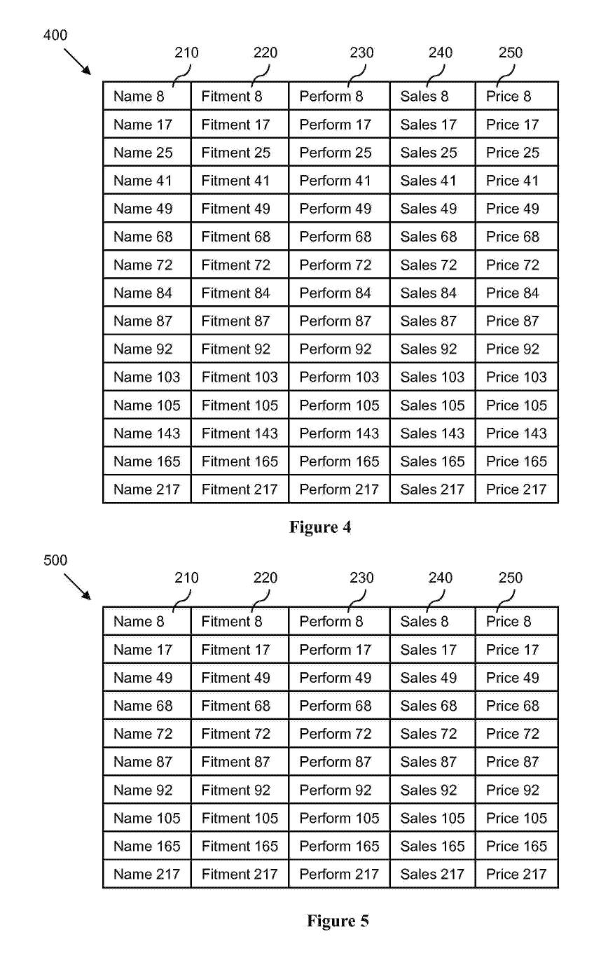

When the tire computer station 110 receives the request 300 for a tire recommendation, it retrieves from the tire database 120 a first set of tire names having associated vehicle fitment data 220 that corresponds to the vehicle data 310. FIG. 4 illustrates exemplary data in one embodiment of a first set 400 of tire names. In one embodiment, the vehicle fitment data 220 includes a list of compatible vehicles. In an alternative embodiment, the vehicle fitment data 220 includes tire and/or vehicle specifications and the tire computer station 110 employs a lookup table to determine tire names 210 that are compatible with the vehicle data 310.

It should be understood that other data may be used to select tire brands from a tire set. For example, there may be correlations between tire brands and a specific demographic of population, or a specific geographic region. There may also be correlations between the year, make, and/or model of a vehicle and a specific tire brand. It should be understood that any such correlations may be employed by the tire recommendation engine to select a set of tire names or weigh certain tire names more heavily or less heavily.

After the first set 400 of tire names is retrieved, the tire computer station 110 selects a first criteria. The tire computer station 110 then identifies a second set of tire names by filtering the first set 400 of tire names to remove tire names having associated tire performance data 230 that fails to meet the first criteria. Alternatively, the tire computer station 110 may identify the second set of tire names by identifying tire names in the first set 400 of tire names that have associated tire performance data 230 that meets the first criteria. FIG. 5 illustrates exemplary data in one embodiment of a second set 500 of tire names.

In one embodiment, the first criteria is a tread wear score. The tread wear score may be based on an established standard, or it may be a proprietary number or formula. In one example, where the annual mileage is less than 5,000 miles (or the annual mileage score is 1), tires having a tread wear score above a first threshold are included in the second set 500 of tire names. In the same example, where the annual mileage is between 5,000 miles and 10,000 miles (or the annual mileage score is 2), tires having a tread wear score above a second threshold are included in the second set 500 of tire names. In the same example, where the annual mileage is between 10,000 miles and 15,000 miles (or the annual mileage score is 3), tires having a tread wear score above a third threshold are included in the second set 500 of tire names. In the same example, where the annual mileage is between 15,000 miles and 20,000 miles (or the annual mileage score is 4), tires having a tread wear score above a fourth threshold are included in the second set 500 of tire names. In the same example, where the annual mileage is greater than 20,000 miles (or the annual mileage score is 5), tires having a tread wear score above a fifth threshold are included in the second set 500 of tire names.

In one embodiment, each of the first, second, third, fourth, and fifth threshold are different tread wear scores. In an alternative embodiment, one or more of the first, second, third, fourth, and fifth threshold may be the same tread wear score. It should be understood that one or more of the first, second, third, fourth, and fifth threshold may be zero, in which case all tires in the set are included in the second set 500 of tire names. In an alternative embodiment, the vehicle age or the vehicle age score may also be used to calculate one or more additional thresholds. In one embodiment, where a certain threshold would result in an empty set, a lower threshold is applied. For example, if the fourth and fifth threshold would result in an empty set, the third threshold will be applied even if the annual mileage score is 4 or 5.

In one embodiment, the first criteria is a traction score. The traction score may be based on an established standard, or it may be a proprietary number or formula. In one example, where the weather condition is “hot sunny days” (or the weather condition score is 1), tires having a traction score above a first threshold are included in the second set 500 of tire names. In the same example, where the weather condition is “some rain” (or the weather condition score is 2), tires having a traction score above a second threshold are included in the second set 500 of tire names. In the same example, where the weather condition is “steady rain” (or the weather condition score is 3), tires having a traction score above a third threshold are included in the second set 500 of tire names. In the same example, where the weather condition is “snow, rain, ice” (or the weather condition score is 4), tires having a traction score above a fourth threshold are included in the second set 500 of tire names. In the same example, where the weather condition is “extreme winter” (or the weather condition score is 5), tires having a traction score above a fifth threshold are included in the second set 500 of tire names.

In one embodiment, each of the first, second, third, fourth, and fifth threshold are different traction scores. In an alternative embodiment, one or more of the first, second, third, fourth, and fifth threshold may be the same traction score. It should be understood that one or more of the first, second, third, fourth, and fifth threshold may be zero, in which case all tires in the set are included in the second set 500 of tire names. In one embodiment, where a certain threshold would result in an empty set, a lower threshold is applied. For example, if the fourth and fifth threshold would result in an empty set, the third threshold will be applied even if the weather condition score is 4 or 5.

In one embodiment, the first criteria is a tire performance type. The tire performance type may be based on an established standard, or it may be a proprietary number or formula. In one example, where the driving style is “slow & steady” (or the driving style score is 1), tires having a tire performance type above a first threshold are included in the second set 500 of tire names. In the same example, where the driving style is “easy going” (or the driving style score is 2), tires having a tire performance type above a second threshold are included in the second set 500 of tire names. In the same example, where the driving style is “typical” (or the driving style score is 3), tires having a tire performance type above a third threshold are included in the second set 500 of tire names. In the same example, where the driving style is “spirited” (or the driving style score is 4), tires having a tire performance type above a fourth threshold are included in the second set 500 of tire names. In the same example, where the driving style is “fast & lively” (or the driving style score is 5), tires having a tire performance type above a fifth threshold are included in the second set 500 of tire names.

In one embodiment, each of the first, second, third, fourth, and fifth threshold are different tire performance types. In an alternative embodiment, one or more of the first, second, third, fourth, and fifth threshold may be the same tire performance type. It should be understood that one or more of the first, second, third, fourth, and fifth threshold may be zero, in which case all tires in the set are included in the second set 500 of tire names. In one embodiment, where a certain threshold would result in an empty set, a lower threshold is applied. For example, if the fourth and fifth threshold would result in an empty set, the third threshold will be applied even if the driving style score is 4 or 5.

In one embodiment, if any special conditions are present, they are the first criteria applied to the first set 400 of tire names. In one example, if the only special condition is that the vehicle is used for “off road,” only tires that meet a first performance standard are included in the second set 500 of tire names. In the same example, if the only special condition is that the vehicle is used for “towing things,” only tires that meet a second performance standard are included in the second set 500 of tire names. In the same example, if the only special condition is that the vehicle is used for “heavy loads,” only tires that meet a third performance standard are included in the second set 500 of tire names. In the same example, if multiple special conditions are present, then only tires that meet a fourth performance standard are included in the second set 500 of tire names.

In one embodiment, where two or more history data have the same score, a priority list may be established. For example, the special conditions may have the first priority, the weather condition may have the second priority, the annual mileage may have the third priority, and the driving style may have the fourth priority. However, it should be understood that the history data may be prioritized in any manner.

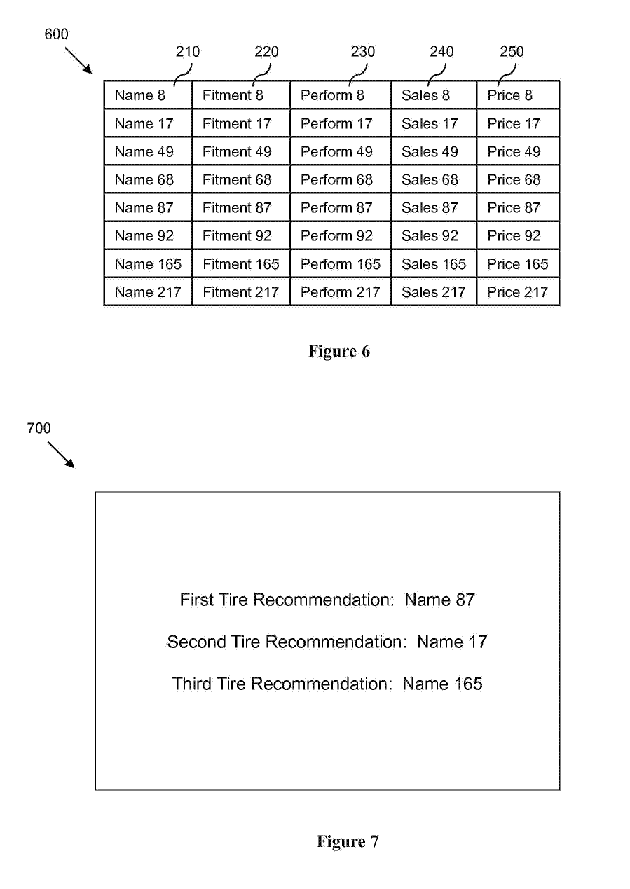

In one embodiment, after the second set 500 of tire names is identified, the tire computer station 110 selects a second criteria based on driver history datum 320. The tire computer station 110 then identifies a third set of tire names by filtering the second set 500 of tire names to remove tire names having associated tire performance data 230 that fails to meet the second criteria. Alternatively, the tire computer station 110 may identify the third set of tire names by identifying tire names in the second set 500 of tire names that have associated tire performance data 230 that meets the second criteria. FIG. 6 illustrates exemplary data in one embodiment of a third set 600 of tire names.

The second criteria may be the same criteria discussed above. In one embodiment, the third set 500 of tire names is the final set of tire names. In an alternative embodiment, additional criteria may be applied before the final set of tire names is established. In another alternative embodiment, the second set of tire names is the final set of tire names.

After the final set of tire names is established, tire recommendations are identified. FIG. 7 illustrates an exemplary display of tire recommendations 700. In one embodiment, the first tire recommendation is the tire name in the final set of tire names that has the highest associated sales history within a specific geographical region for the specific vehicle make and/or model. In alternative embodiments, other criteria may be employed or a weighted score may be calculated.

After the first tire recommendation is identified, a second and third tire recommendation may also be identified. In one embodiment, the second and third tire recommendations are based solely on sales history data. In an alternative embodiment, the second and third tire recommendations are based on both sales history data and price data. For example, the second tire recommendation may be a higher priced tire than the first tire recommendation and identified as a “premium alternative.” The third tire recommendation may be a lower priced tire than the first tire recommendation and identified as a “value alternative.” In an alternative embodiment, the second and third recommendation are not necessarily higher or lower priced than the first tire recommendation, but are selected such that they are priced within a predetermined range of the first tire recommendation.

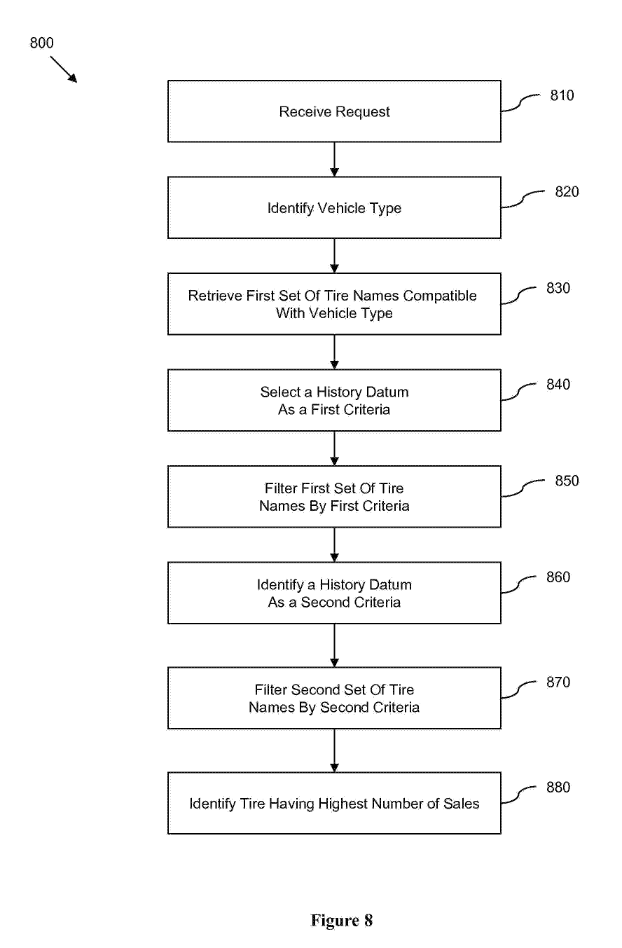

FIG. 8 illustrates a flowchart showing one embodiment of a method 800 for providing a first tire recommendation. The tire recommendation engine receives a request for a tire recommendation (at 810) that includes vehicle data and historical driving data of a user. From the vehicle data in the request, the tire recommendation engine identifies a vehicle type (at 820). The tire recommendation then retrieves a first set of tire names that are compatible with the identified vehicle type (at 830).

The tire recommendation engine also identifies a first criteria (at 840). The tire recommendation engine then filters the first set of tire names by the first criteria (at 850), thereby identifying a second set of tire names.

The tire recommendation engine also identifies a second criteria (at 860). The tire recommendation engine then filters the second set of tire names by the second criteria (at 870), thereby identifying a third set of tire names.

Additional filtering may be done until a final set of tire names is established. After the final set of tire names is established, the tire recommendation engine identifies the tire name in the final set of tire names that has a highest number of sales (at 880) as the first tire recommendation. Alternatively, the tire recommendation engine may use other criteria to identify a first tire recommendation.

In one embodiment, after a final set of tire names is established, the tire recommendation engine identifies a subset of tire names from the final set of tire names that have a lower price than the first recommended tire name. This subset may also be referred to as an alternative set. The tire recommendation engine then identifies the tire name in the subset that has the highest number of sales as the second tire recommendation and the tire name in the subset that has the second highest number of sales as the third tire recommendation. In one embodiment, the tire recommendation engine will also require each of the first tire recommendation, second tire recommendation, and third tire recommendation to be tires of a different brand.

In an alternative embodiment, after the final set of tire names is established, the tire recommendation engine identifies a subset of tire names from the final set of tire names that have a higher price than the first recommended tire name. This subset may also be referred to as an alternative set. The tire recommendation engine then identifies the tire name in the subset that has the highest number of sales as the second tire recommendation and the tire name in the subset that has the second highest number of sales as the third tire recommendation. In one embodiment, the tire recommendation engine will also require each of the first tire recommendation, second tire recommendation, and third tire recommendation to be tires of a different brand.

In another alternative embodiment, after the final set of tire names is established, the tire recommendation engine identifies a first subset of tire names from the final set of tire names that have a higher price than the first recommended tire name. This subset may also be referred to as a first alternative set. The tire recommendation engine then identifies the tire name in this subset that has the highest number of sales as the second tire recommendation. In one embodiment, the tire recommendation engine will also require the first tire recommendation and second tire recommendation to be tires of a different brand.

In this embodiment, the tire recommendation engine also identifies a subset of tire names from the final set of tire names that have a lower price than the first recommended tire name. This subset may also be referred to as a second alternative set. The tire recommendation engine then identifies the tire name in the subset that has the highest number of sales as the third tire recommendation. In one embodiment, the tire recommendation engine will also require each of the first tire recommendation, second tire recommendation, and third tire recommendation to be tires of a different brand.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative apparatus and method, and illustrative examples shown and described. Accordingly, departures may be made from such details without departing from the spirit or scope of the applicant's general inventive concept.

1-20. (canceled)

21. A method for recommending a tire to a user, the method comprising:
receiving, at a computer, a request for a tire recommendation generated by the user in response to a vehicle question and driver history question comprising an annual mileage question, wherein the request includes vehicle data and driver history data comprising an annual mileage datum associated with a vehicle;
determining, at the computer, a vehicle type based on the vehicle data;
retrieving, at the computer, via a lookup table, a set of tire names from a database based on the determined vehicle type, wherein each tire name is associated with vehicle fitment data, tire performance data, sales history data, and price data;
assigning, at the computer, a score to the driver history data;
filtering, at the computer, the set of tire names to generate a filtered set of tire names according to the assigned score to the driver history data based on a comparison of tire performance data associated with the set of tire names relative to a criteria;
identifying, at the computer, a given tire name from the filtered set of tire names having a highest associated sales history datum as a first tire recommendation;
identifying, at the computer, another tire name from the filtered set of tire names having an associated price value that is greater than the first tire recommendation as a second tire recommendation; and
generating, at the computer, tire recommendation data characterizing the identified first tire recommendation and the second tire recommendation.

22. The method of claim 21, wherein filtering, at the computer, the set of tire names to generate the filtered set of tire names according to the assigned score to the driver history data based on the comparison of tire performance data associated with the set of tire names relative to the criteria comprises one of:
removing a subset of tire names from the set of tire names having associated tire performance data that fail to meet the criteria to generate the filtered set of tire names; and
identifying a subset of tire names in the first set of tire names that have associated tire performance data that meet the criteria to generate the filtered set of tire names.

23. The method of claim 21,
wherein the criteria is one of a tread wear score threshold, a traction score threshold and a tire performance type threshold value; and
wherein the tire performance data comprises one of a tread wear score, traction score and a tire performance type value.

24. The method of claim 23, further comprising transmitting the tire recommendation data to a user device for display, wherein the user device is one of a laptop and a mobile device.

25. The method of claim 21, wherein the driver history data further comprises weather condition datum, and driving style datum.

26. The method of claim 21, wherein the vehicle data comprises a vehicle age datum.

27. The method of claim 26, wherein the filtering of the set of tire names is further based on determining whether to remove tire names from the set of tire names based on the vehicle age datum.

28. The method of claim 21, further comprising identifying, at the computer, a third tire recommendation from the filtered set of tire names that meets a sales history criteria.

29. The method of claim 28, further comprising identifying, at the computer, a fourth tire recommendation from the filtered set of tire names that meets a second sales history criteria.

30. A method for generating a tire recommendation, comprising:
receiving, at a computer, a request for a tire recommendation generated by the user in response to a vehicle question and driver history question comprising an annual mileage question, wherein the request includes vehicle data and driver history data comprising an annual mileage datum associated with a vehicle;
determining, at the computer, a vehicle type based on the vehicle data;
retrieving, at the computer, via a lookup table, a set of tire names from a database based on the determined vehicle type, wherein each tire name is associated with vehicle fitment data, tire performance data, sales history data, and a price data;
assigning, at the computer, a score to the driver history data;
filtering, at the computer, the set of tire names to generate a filtered set of tire names according to the assigned score to the driver history data based on a comparison of tire performance data associated with the set of tire names relative to a criteria;
identifying, at the computer, a given tire name from the filtered set of tire names having a highest associated sales history datum as a first tire recommendation;
identifying, at the computer another tire name from the final set of tire names having an associated price value that is lower than the first tire recommendation as a second tire recommendation; and
generating, at the computer, tire recommendation data characterizing the identified the first tire recommendation and the second tire recommendation.

31. The method of claim 30, further comprising selecting, at the computer, a second criteria based on the driving data.

32. The method of claim 31, filtering, at the computer, the filtered set of tire names to generate a further filtered set of tire names based on identifying tire names in the filtered set of tire names that have associated tire performance data that meets the second criteria.

33. The method of claim 30, wherein the driving data comprises at least one of a weather datum, and a driving style datum.

34. The method of claim 30, wherein the second tire recommendation is identified from the filtered set of tire names based at least on a sales history criteria.

35. The method of claim 34, further comprising identifying, at the computer, a third tire recommendation from the filtered set of tire names that meets a second sales history criteria and a second price criteria.

36. The method of claim 30,
wherein the criteria is one of a tread wear score threshold, a traction score threshold and a tire performance type threshold value; and
wherein the tire performance data comprises one of a tread wear score, traction score and a tire performance type value.

37. The method of claim 36, further comprising transmitting the tire recommendation data to a user device for display, wherein the user device is one of a laptop and a mobile device.

38. A method for recommending a tire, comprising:
receiving, at a computer, a request for a tire recommendation generated by the user in response to a vehicle question and driver history question comprising an annual mileage question, wherein the request includes vehicle data and driver history data comprising an annual mileage datum associated with a vehicle;
determining, at the computer, a vehicle type based on the vehicle data;
retrieving, at the computer, via a lookup table, a set of tire names from a database based on the determined vehicle type, wherein each tire name is associated with vehicle fitment data, tire performance data, sales history data, and a price data;
assigning, at the computer, a score to the driver history datum;
filtering, at the computer, the set of tire names to generate a filtered set of tire names according to the assigned score to the driver history data based on a comparison of tire performance data associated with the set of tire names relative to a criteria;
identifying, by the computer, a given tire name from the filtered set of tire names having a highest associated sales history datum as a first tire recommendation;
identifying, by the computer another tire name from the filtered set of tire names having an associated price value that is greater than the first tire recommendation as a second tire recommendation and a third tire name from the filtered set of tire names having a lower price than the first tire recommendation as a third tire recommendation; and
generating, at the computer, tire recommendation data characterizing the identified the first tire recommendation, the second tire recommendation, and the third tire recommendation.

39. The method of claim 38,
wherein the criteria is one of a tread wear score threshold, a traction score threshold and a tire performance type threshold value; and
wherein the tire performance data comprises one of a tread wear score, traction score and a tire performance type value.

40. The method of claim 39, further comprising transmitting the tire recommendation data to a user device for display, wherein the user device is one of a laptop and a mobile device.
